(19) United States
(12) Patent Application Publication
(10) Pub. No.: US 2004/0217987 A1
(43) Pub. Date: Nov. 4, 2004

(54) Method and system for intercepting and processing data during GUI session

(76) Inventor: Solomo Aran, Karnei Shomron (IL)

Correspondence Address: KATTEN MUCHIN ZAVIS ROSENMAN, 575 MADISON AVENUE, NEW YORK, NY, 10022-2585, US

(21) Appl. No.: 10/427,851

(22) Filed: May 1, 2003

(51) Int. Cl. G09G 5/00

(52) U.S. Cl. 345/769

(57) ABSTRACT

The present invention discloses a new method for data processing of a real time GUI session activities, enabling to intercept, identify and record inserted data. The data processing is based on activation of pre-defined control commands that are based on pre-analysis of GUI dialog operation. The data processing application continuously intercepts user or operating systems activities, identifies GUI triggering events that indicate user or operating system activities and activates the pre-defined control commands of data identification, data recordation, data writing, navigation and initiation of GUI events in accordance with triggering events and intercepted data;

### FIELD OF THE INVENTION

The present invention relates to the field of GUI application operation analysis, and more specifically to a system and method for intercepting data that is inserted during GUI session and converting the data contained therein into a new format.

### BACKGROUND OF THE INVENTION

Users of multiple software applications sometimes use several database applications of different formats. Often, the need arises to transfer data records contained within one application to another. The means for seamless transfer between different applications is therefore indispensable in ensuring data exchange between different applications.

Applications that operate within the same multitasking operating system include data capturing and transferring functions. A very common feature within application programs such as word-processors or text editors within graphical user interfaces (GUI), such as window-based environments, is the clipboard for capturing window data. The clipboard allows the user to use functions that transfer text—or characters in general—from one place to another within the same application program, or to another application program when feasible. Examples of such functions are the well-known cut-and-paste or copy-and-paste functions. These functions use a buffer memory (which is the clipboard in the Windows OS) for storing the text or characters that are to be copied or transferred from one place to another. The common way for selecting a portion of a screen to be copied or moved is to execute the dragging function with the mouse as well as to perform the transfer itself (by use of cut-and-paste functions). While the mouse is the most common selecting device used, in some applications the selection is done using the keyboard (e.g. the VI editor in UNIX environment). In cases whereby the application uses its own clipboard, which is distinct from the operating system's clipboard (e.g. some text editors), the user is provided with cut-and-paste or copy-and-paste functions that work only within the same application but not for transferring data to another application.

In other cases, the application may not provide the user with such a mechanism at all. In general applications such as graphic/image display, terminal emulators, data communication programs (i.e. modem and faxing programs) and Internet access software generally do not offer a simple and easy to use mechanism to acquire data from one program and to route it to a different destination. In such cases, the user is required to print the screen or manually copy the text that he wants to keep a record of.

Considering the important development of graphical applications (e.g. within the Internet network) whereby the user may want to store or catch information, it would be very useful for the user to be provided with a system that would offer the capability of a copy/cut-and-paste function that is usable in any window-based application for transferring portions of the screen (text or graphic) into a file or to another portion of the screen within or not the same application

The methods described above have one major disadvantage: the applications must have been pre-designed and coded to specifically support these data exchange methods.

Screen capture programs, well known in the prior art, offer an alternative to the clipboard for capturing window data, but they too suffer from disadvantages. Screen capture programs operate on the basis of the level of screen memory. They allow a user to capture any portion of the actual visible screen without regard to the type of data being displayed. Captured data is by necessity stored as bitmapped graphic data. It is impossible to capture a text portion of a screen corresponding to, for example, a word processor and store the captured data as text or string data (e.g., in ASCII format), without additional processing such as optical character recognition (OCR). Thus, screen capture programs suffer from inability to store the data captured in the data's native format.

U.S. Pat. No. 5,392,386, issued to Chalas, teaches a system for adding functions to an existing application program, executed in a computer system that has a GUI interface and includes a clipboard. The system intercepts communications between the OS and the application program and determines when the user is invoking one of the added functions. The system sends captured information to the clipboard in response to user commands.

U.S. Pat. No. 6,222,542, discloses a method for acquiring, processing and routing text and/or bitmap data selected or entered by a user. The method comprises of the steps of acquiring the data (in native text and bitmap format) from a window, storing the acquired data in a data buffer, and processing the data stored in the data. This method of capturing inserted data lacks the ability to identify the context of the data being captured, thus the acquired data interpretation and/or usage may not necessarily be correct.

When dealing with databases, copy/cut-and-paste methods or other data capturing methods are not sufficient as the data is stored according to the predefined rules of the database application used. Since database applications can have many different formats and therefore different rules, copying and moving data between applications require converting between formats as well. Therefore the task is much more difficult than a normal copy/cut-paste operation and requires a more complex solution.

### BRIEF DESCRIPTION OF THE DRAWINGS

These and further features and advantages of the invention will become better understood in light of the ensuing description of a preferred embodiment thereof, given by way of example only, with reference to the accompanying drawings, wherein

FIG. 1 is a block diagram of operative components according to the present invention;

FIG. 2 is a flow chart of GUI dialog elements identification according to the present invention;

FIG. 3 is a flow chart of the script editor operation according to the present invention;

FIGS. 4a and 4b are a flow chart of GUI dialog pictorial elements identification according to the present invention;

FIG. 5 is a flow chart of the dialog wizard operation according to the present invention;

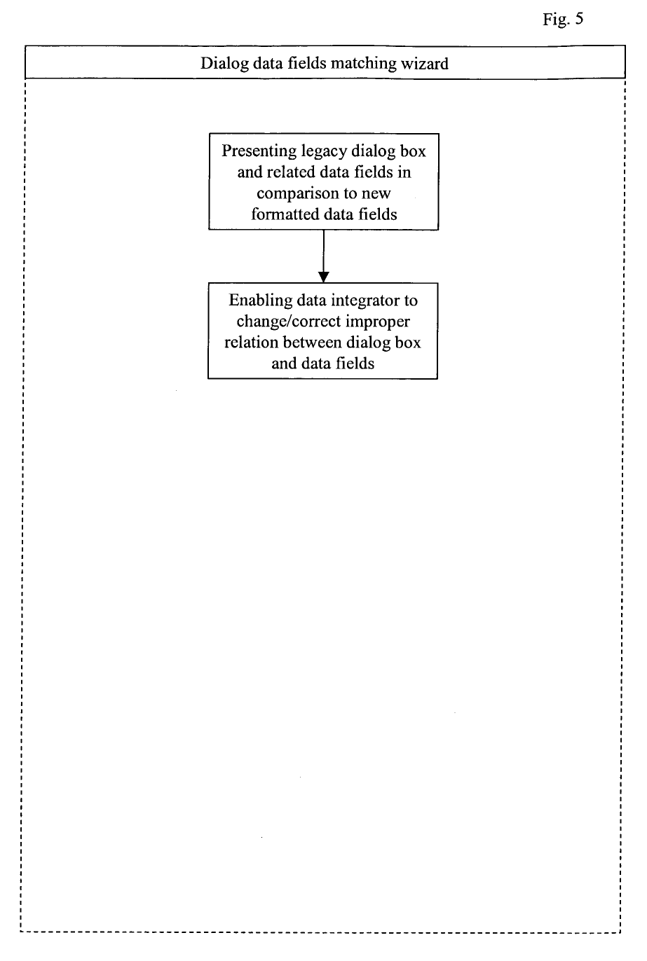

### SUMMARY

The present invention discloses a new method for data processing of a real time GUI session activities, enabling to capture (intercept, identify and record) inserted data wherein the data processing is based on activation of pre-defined control commands wherein said control commands are based on pre-analysis of GUI dialog operation, said method comprising the steps of: continuously intercepting user or operating system's activities; Identifying GUI triggering events which indicate user activity or operating system activities; activating the pre-defined control commands of data identification and data recordation, data writing, navigation and initiation of GUI events in accordance with triggering events and intercepted data;

### DETAILED DESCRIPTION OF THE PREFERRED EMBODIMENTS

The present invention provides a new concept for capturing data that is inserted during GUI sessions. This capturing process is activated upon the occurrence of specific “triggering” events. It applies record-play techniques according to pre-defined script commands, which are generated on the basis of pre-analysis of the GUI dialog operation and GUI object identification.

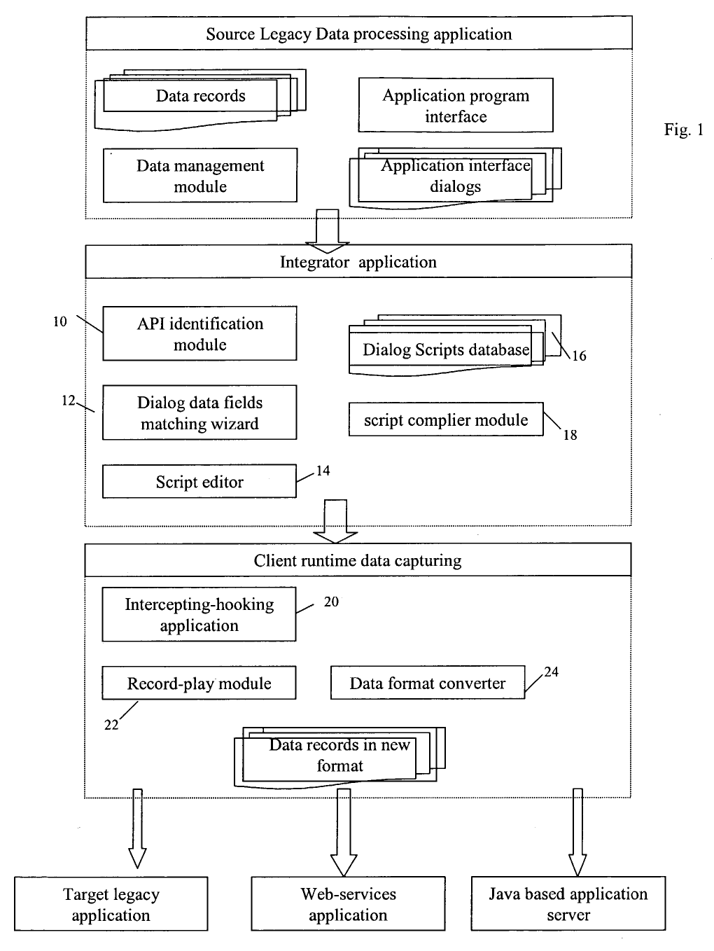

FIG. 1 illustrates a block diagram of the operative components according to the present invention. The first section of the diagram illustrates the basic parts of conventional data management applications comprising of a management module, database, and API. The application interface includes GUI dialog screens, each designated for inserting different data records.

The pre-analysis process of the GUI dialog includes two main stages: automatic analysis of the GUI objects and the dialog activities, and manual adjustment and verification of this automatic analysis.

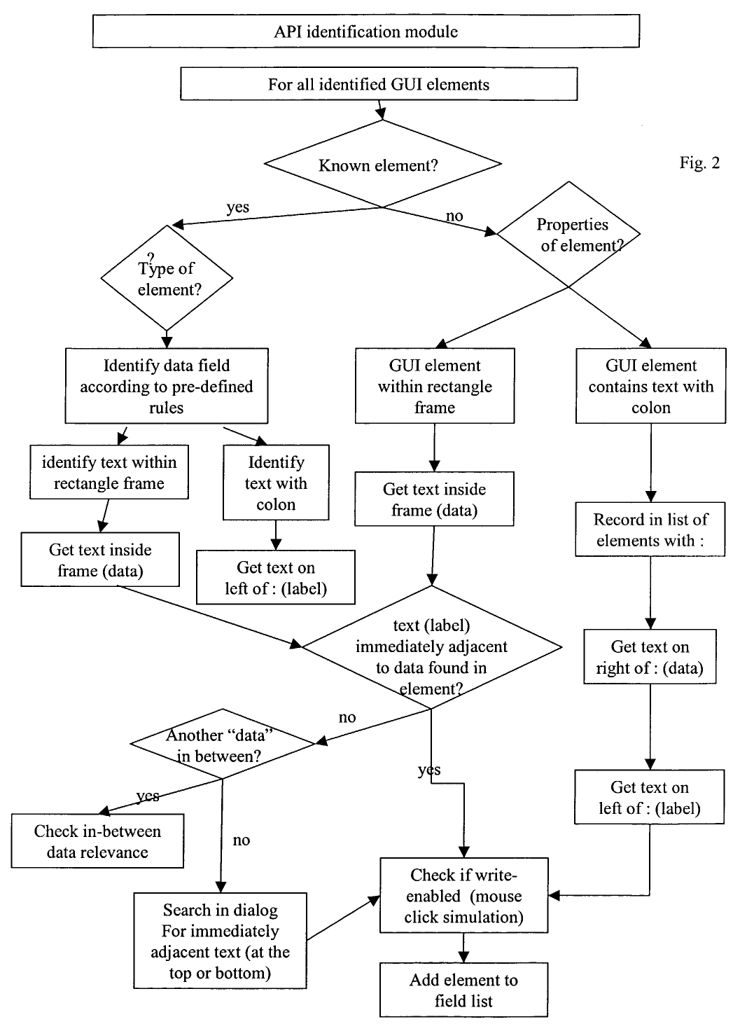

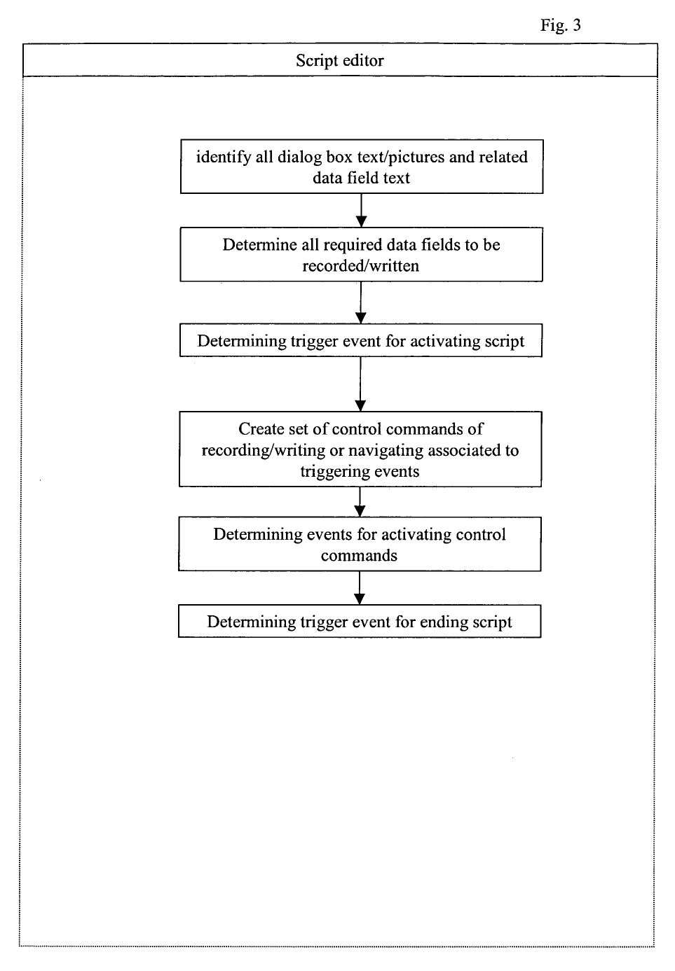

The second section in FIG. 1 illustrates an integration application for creating control commands script (using record/play techniques) for the specific management application dialogs. Each GUI dialog is analyzed for the purpose of identifying its objects type and format, and understanding its interaction with the user (API identification module(10), see FIG. 2). Based on said analysis using the dialog data fields matching wizard (12), the human integrator is provided with the relevant identified data fields as compared to the GUI dialog data fields. The integrator may then approve the results suggested by the automatic analysis or make any corrections necessary. At the next stage, the script editor (14) (See FIG. 3) creates control commands, including data identification and recordation commands. Each command correlates to an identified “triggering” event of the GUI interactive operation.

Finally the commands script are compiled by the script compiler module (16) and stored at the Dialog Scripts database (18).

The third section of the block diagram illustrates the run-time script application. This application includes a hooking and interception module (20), which contentiously identifies user interactions with the GUI dialog and operating system activities. The record-play module (22) activates the recorded scripts' commands according to identified triggering events. The scripts control commands identify the intercepted data and generate the respective data records in a new format (data format converter(24)). According to preferred option of the present invention, such data format is compatible with web-service applications. The control commands may further initiate new GUI events such as activating external GUI element for receiving complementary data from the user.

The present invention discloses new techniques for parsing GUI dialogs and identifying different GUI objects and their inner relations. Although the GUI screen dialog can be easily understood by a human operator, who can detect the dialog boxes for data insertion and identify the related text, computerized analysis of this information is a complex task. The basic idea that lies behind the GUI analysis algorithm is to identify characteristic patterns of the dialog boxes and deduce each GUI object function and format accordingly.

The algorithm for identification of the GUI elements is illustrated in FIG. 2 At the first stage of the algorithm, the GUI elements are classified according to their type: (e.g. Edit Box, Static, Button, Check Box, Radio button etc.). Such classification and GUI elements analysis is based on known GUI elements characteristics. Such GUI characteristics can be used for identifying data fields and related data labels for known GUI elements.

In any case, for all GUI elements in the dialog, the algorithm identifies the properties of the GUI object. For example, text immediately followed by a colon is identified and recorded as labels, all text appearing within a rectangle, is identified and recorded as data fields. The relation between the labels and data fields is determined by detecting immediate adjacent GUI elements. When the label and data fields are immediately adjacent, the algorithm searches for next immediately adjacent text, beneath or above the label field.

Secondly, the algorithm checks the if GUI element is designed to provide the user with writing data into the respective field parameter. The identification of write enabled GUI elements can be done by simulating a mouse click.

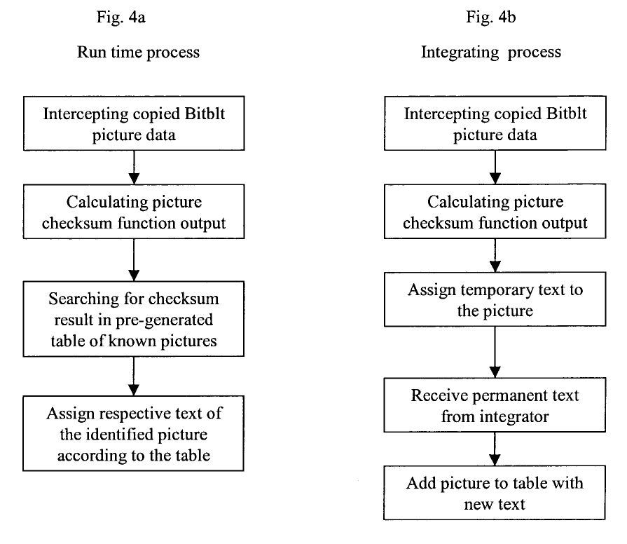

FIGS. 4a and 4b show how graphical representation of data can also be recognized and interpreted by the system suggested in the present invention. Pictures such as check marks are sometimes used instead of text when appropriate in regard to the type of data. To interpret these types of records, a table of well-known or standardized pictures used in many database applications is provided with the system. These pictures are converted to code and the table includes the pictures' code and the corresponding data that each picture represents (in text).

Upon configuration of the system to correspond to a certain database application, the pictures corresponding to this application are encountered. Each time this happens, the picture is first converted to code and compared to pictures in the table. If there is no match, the picture is given a temporary name (the text) and stored in the table. The integrator may then manually assign text to the picture, after which it is permanently stored in the table with its corresponding text. This is a one-time process, after which the system will always recognize the particular picture.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A method for data processing of a real time GUI session activities enabling to intercept, identify and record inserted data wherein the data processing is based on activation of pre-defined control commands wherein said control commands are based on pre-analysis of GUI dialog operation, said method comprising the steps of:
A. continuously intercepting user or operating systems activities;
B. Identifying GUI triggering events which indicate user or operating system activities;
C. activating the pre-defined control commands of data identification, data recordation, data writing, navigation and initiation of GUI events in accordance with triggering events and intercepted data;

2. The method of claim 1 wherein the data identification command includes identification of data type and association of data to pre-defined labels.

3. The method of claim 1 wherein the data recordation command includes assignment of identified data to receptive database according to identified data labels.

4. The method of claim 1 wherein the initiation of GUI events includes activation of a new GUI element for receiving complementary data.

5. The method of claim 1 wherein the pre-analysis of the GUI interface dialog operation comprises the steps of:
A. identifying dialog GUI objects;
B. for GUI objects of a known type—identifying data field and related label text according to predefined rules;
C. for GUI object of an unknown type—identifying dialog box text and related data fields by identifying characteristics of GUI object and identifying approximation between texts and data fields;

6. The method of claim 5 wherein the GUI element identifying characteristics are colons and rectangular frames.

7. The method of claim 5 wherein the approximation is identified by checking immediately adjacent GUI elements.

8. The method of claim 5 further comprising the step of simulating the mouse operation relating each GUI object for checking if the GUI element is writable.

9. The method of claim 6 further comprising the step of identifying pictorial data by intercepting drawing function activation and computing the checksum parameter of pictures wherein each checksum value is associated with predefined text label.

10. The method of claim 6 further comprising the step of enabling the user to check and correct the automatic pre-analysis of the GUI objects;

11. The method of claim 6 further comprising the step of analyzing GUI dialog operation and generating the pre-defined control commands by using record-play techniques wherein each command is relates to a corresponding triggering event(within the GUI dialog).

12. A system for data processing of a real time GUI session activities enabling to capture, intercept, identify and record inserted data wherein the data processing is based on activation of pre-defined control commands wherein said commands are based on pre-analysis of GUI dialog operation, said method comprising the steps of:
D. interception module enabling continuous interception of user or operating systems activities;
E. identification module for detecting GUI triggering events which indicate user activity or operating system activities;
F. Runtime script program comprising pre-defined control commands of data identification, data recordation, navigation and initiation of GUI events wherein said commands are associated with triggering events intercepted data;

13. The system of claim 12 wherein the data identification command includes identification of data type and association of data to pre-defined labels.

14. The system of claim 12 wherein the data recordation command includes assignment of identified data to receptive database according to identified data labels.

15. The system of claim 12 wherein the initiation of GUI events includes activation of new GUI new GUI element for receiving complementary data.

16. The system of claim 12 wherein the pre-analysis of the GUI interface dialog operation comprises Identification module for identifying GUI objects data fields and relevant label wherein the analysis of known GUI elements is processed according to predefined rules and wherein the identification of unknown GUI elements is processed by detecting characteristics of the GUI elements and identifying approximation between texts and data fields;

17. The system of claim 16 wherein the GUI identifying characteristics elements are colons and rectangular frames.

18. The system of claim 16 wherein the approximation is identified by checking immediately adjacent GUI elements.

19. The system of claim 16 further comprising of simulation module checking mouse click operation relating each GUI object for checking if the GUI element is writable.

20. The system of claim 16 further comprising pictorial data identification module which intercepts the activation of drawing function and computes the checksum parameter of the picture wherein each checksum value is associated with predefined text label.

21. The system of claim 16 further comprising the wizard module enabling the user to check and correct the automatic pre-analysis of the GUI objects;

22. The method of claim 16 further comprising of GUI dialog operation analysis for generating the pre-defined control commands wherein the analysis module is based on record-play techniques and each command is associated with a relevant corresponding triggering event within the GUI dialog.
